(19) United States
(12) Patent Application Publication
(10) Pub. No.: US 2006/0084437 A1
(43) Pub. Date: Apr. 20, 2006

(54) Soft handover control method, soft handover control program and mobile communication terminal device

(75) Inventor: Tomoki Furuya, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/242,914

(22) Filed: Oct. 5, 2005

(30) Foreign Application Priority Data
Oct. 6, 2004 (JP) 2004-294287

(51) Int. Cl. H04Q 7/20

(52) U.S. Cl. 455/436

(57) ABSTRACT

When the calling out of a mobile communication terminal connected to a base station by a RL causes a control unit in the terminal to start a call connection sequence, and the electric field level measurement of a base station pilot signal after transition to a CELL_DCH state causes a handover event to occur, the control unit compares the electric field level for pilot signal reception of the currently connected base station with a prescribed threshold, and, as a result of the comparison, if the electric field level of the currently connected base station is equal to or less than the threshold, the call connection sequence is interrupted to perform the handover operation, and the call connection sequence is resumed after the handover operation is completed. Conversely, if the electric field level of the currently connected RL is greater than the threshold, the call connection sequence is continued without performing the handover operation.

### BACKGROUNDS OF THE INVENTION

1. Field of the Invention

The present invention relates to a soft handover control method and a mobile communication terminal device in a mobile communication system using Code Division Multiple Access (CDMA).

2. Description of the Related Art

In a mobile communication system, a base station in charge of communicating with a mobile communication terminal device, such as a mobile phone, is located in each area, and when the mobile communication terminal device communicates while moving across a plurality of areas, a handover control is performed, which switches the base station to which the mobile communication terminal device is wirelessly connected according to the movement of the mobile communication terminal device, in order to prevent the communication from being interrupted.

In particular, in the mobile communication system that uses CDMA, a soft handover method is employed, in which a mobile radio terminal taking advantage of CDMA sends and receives a signal between two or more base stations at the same time, thereby establishing simultaneously two or more communication paths for one call, to maintain continuity of the call (See Japanese Patent Laid-open (Kokai) No. 2001-238248, and Japanese Patent Laid-open (Kokai) No. 2004-180205).

FIG. 3-5 illustrate one example of conventional soft handover control technology, in which FIG. 3 shows a schematic diagram illustrating the partial configuration of a mobile network using CDMA, FIG. 4 shows a timing chart of a soft handover operation, and FIG. 5 shows a flow chart of the soft handover operation. The outline of the soft handover control operation will now be described, with reference to FIG. 3-5.

A mobile station (e.g. mobile phone) M that is making a call to a base station A is always monitoring a pilot signal from each base station. If the mobile station M moves from an area of the base station A to an area of a base station B adjacent to the base station A during its call, causing the pilot signal from the base station B to become greater than the threshold LADD for channel connection, the mobile station M sends a pilot signal measurement message (PSMM) signal to the base station A (S10).

When the base station A receives the PSMM signal, the signal is sent to a control station, which, in turn, instructs the base station B to assign a call channel. The base station B starts sending traffic on a downlink traffic channel, and seizes an uplink traffic channel. Then, to allow the mobile station M to use both base stations A and B, the base station B sends a handover direction message (HDM) signal to the mobile station M (S11).

Upon receiving the HDM signal and seizing the base station B, the mobile station M moves the base station B into an Active Set, and sends a handover completion message (HCM) signal to both base stations A and B (S12). In this way, the mobile station M establishes communication paths to, and starts communicating with, the base stations A and B, completing the handover. The Active Set means a collection of base stations with which the mobile station has established a communication path.

If the intensity of the pilot signal of the base station A becomes equal to or less than LDROP while the mobile station M is making a call to the base stations A and B, and this state continues for a time period of TDROP or longer, the mobile station M sends a PSMM signal for the pilot signal of the base station A to the base stations A and B (Sl3). The base stations A and B, which have received the PSMM signal, send the mobile station M an HDM signal that indicates to use the base station B only (Sl4).

The mobile station M, which has received the HDM signal, stops the reception by diversity synthesis from the base station A, moves the base station A into a Neighbor Set, and sends the HCM signal to the base stations A and B (S15). The Neighbor Set means a collection of candidate base stations that can be added to the Active Set. When the base stations A and B receive the HCM signal, the traffic channel assigned to the base station A is deassigned. Therefore, the communication continues thereafter using the RL with the base station B.

In a W-CDMA mobile communication system, before the mobile station performs call connection processing, i.e., in the IDLE state, in the CELL_PCH (Paging Channel) state, in which a paging signal is being sent on a downlink common channel, or in the CELL_FACH (Forward Access Channel) state, in which control information and user data are being sent on the downlink common channel, communication is through a common channel only, such that only one base station (Radio Link, hereafter referred to as RL) (1RL) is connectable, whereas, when a call connection processing starts, and the state transitions to a CELL_DCH (Dedicated Channel) state, in which the user data start to be sent on a bi-directional channel, communication with 2RL and 3RL (soft handover state) becomes possible.

Thus, immediately after the mobile phone using W-CDMA from before performing the call connection operation, i.e., in the IDLE, the CELL_PCH, or the CELL_FACH state, started call connection operation and transitioned to the CELL_DCH state, in particular, the handover event to add an RL to be connected occurs more easily, and the additional handover event is performed in priority to a call connection sequence.

In this manner, conventionally, when a handover event to add an RL occurs, the handover operation is performed in priority to the call connection sequence, raising the problem of the call connection operation being postponed and leading to extra time to connect a call. In addition, after an RL has been added and the soft handover state has been entered, if a handover event to remove the first RL occurs, it takes even more extra time to perform the call connection operation.

As means to bypass these problems, a method is considered, which imposes a limitation that prevents the handover event from occurring during the call connection operation, and performs the call connection operation in priority. In this case, if the electric filed level of the RL connected at the start of the call connection operation is in a good enough condition, it is possible to complete the call connection within a short time; however, there is a problem that, if the electric field level of 1RL connected at the start of the call connection is low, the call connection operation itself will fail. Because the value of the above-described threshold LADD to connect a channel is generally set to be a relatively low value such that the mobile station can rapidly secure the 1RL, the call connection operation may fail due to the above-described limitation.

Thus, in the conventional soft handover control method, when a handover event occurs during a call connection operation, if the handover sequence is performed in priority to the call connection sequence, there is the problem that it takes as much extra time to connect a call as it took to perform the handover operation, and if the call connection sequence is executed in priority to the handover sequence, there is the problem that the call connection may fail.

### SUMMARY OF THE INVENTION

In view of the above-described problems, an object of the present invention is to provide means for minimizing the effect on the call connection operation time and at the same time preventing a call connection from failing, when a handover event occurs during a call connection operation.

The soft handover control method of the present invention is characterized by a control upon detection of the occurrence of a handover event while a mobile phone using CDMA is performing a call connection operation, of switching between giving priority to the continuation of the call connection sequence and giving priority to the handover sequence, depending on the electric field level of the currently connected Radio Link (RL).

If the electric level of the currently connected Radio Link (RL) is greater than the minimum value of the electric level required for the call connection to succeed, the handover operation is interrupted and the call connection sequence is continued by priority, and if it is equal to or lower than the minimum value of the electric level required for the call connection to succeed, the handover sequence is performed by priority, and the call connection sequence is continued after a soft handover state is entered.

A characteristic of the mobile connection terminal device using CDMA of the present invention is to comprise a pilot signal level measurement unit which periodically receives a pilot signal sent from each base station and measuring the reception level thereof, unit which establishes a Radio Link (RL) with a base station for which the level of the received pilot signal measured by the pilot signal level measurement unit is greater than a first threshold, unit which causes a handover event, unit which executes a call connection sequence via the base station for which the Radio Link (RL) is established according to a calling direction entered via a keyboard, a comparison unit for comparing with a preset second threshold the pilot signal level received from the base station for which the Radio Link (RL) is established when the handover event occurs while the call connection sequence is being executed, and unit which continues the call connection sequence without performing the soft handover operation due to the handover event if the pilot signal level received from the base station for which the Radio Link (RL) is established is greater than the second threshold as a result of the comparison by the comparison unit, and performing the soft handover operation due to the handover event if the pilot signal level received from the base station for which the Radio Link (RL) is established is equal to or less than the second threshold, and then continuing the call connection sequence after the soft handover operation is completed.

The handover event is organized so as to occur when a second base station that can receive a greater pilot signal than the first threshold is detected by the pilot signal level measurement unit, or when the difference between the pilot signal level received from the base station for which the Radio Link (RL) is established and the pilot signal reception level from the second base station is equal to or less than a prescribed value.

The second threshold has a greater value than the first threshold for establishing the Radio Link (RL), and is set to the minimum electric field level required for the call connection to succeed.

A characteristic of the program of the present invention for a control unit included in a mobile communication terminal device using CDMA to perform a soft handover control is to cause the execution of the process of detecting the occurrence of a handover event during a call connection operation, the process of comparing the electric field level of the currently connected Radio Link (RL) with a preset threshold when the occurrence of the handover event is detected, the process of controlling the continuation of the call connection operation if the electric level of the currently connected Radio Link (RL) is greater than the threshold, and the process of controlling the continuation of the call connection operation after performing the handover sequence in priority if the electric level of the currently connected Radio Link (RL) is equal to or less than the threshold.

The threshold is set to the minimum electric field level required for the call connection to succeed, its optimum value is determined through tests performed by terminal developing manufacturers or carriers, and is stored in advance in a memory inside the mobile communication terminal device as a preset value. Upon instruction for comparison by the program, the value is read from the memory by the control unit, and compared with the electric field level of the currently connected Radio Link (RL).

That is to say, in the present invention, when the electric level of the connected RL is at an electric level that is sufficient as not to cause failure of the call connection even if the soft handover is not performed, priority is given to the call connection sequence to prevent extra time from being taken to connect a call, whereas with such level that would cause the call connection to fail if the soft handover is not performed, priority is given to the soft handover sequence to prevent the call connection from failing.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram illustrating the configuration of the embodiment of a mobile communication terminal device, such as mobile phone, to which the present invention is applied;

FIG. 2 is a flow chart describing a handover control operation in the embodiment of the present invention;

FIG. 3 is a schematic diagram illustrating the partial configuration of a mobile network using CDMA;

FIG. 4 is a timing chart illustrating an example of a conventional soft handover operation; and

FIG. 5 is a flow chart illustrating the conventional soft handover operation.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

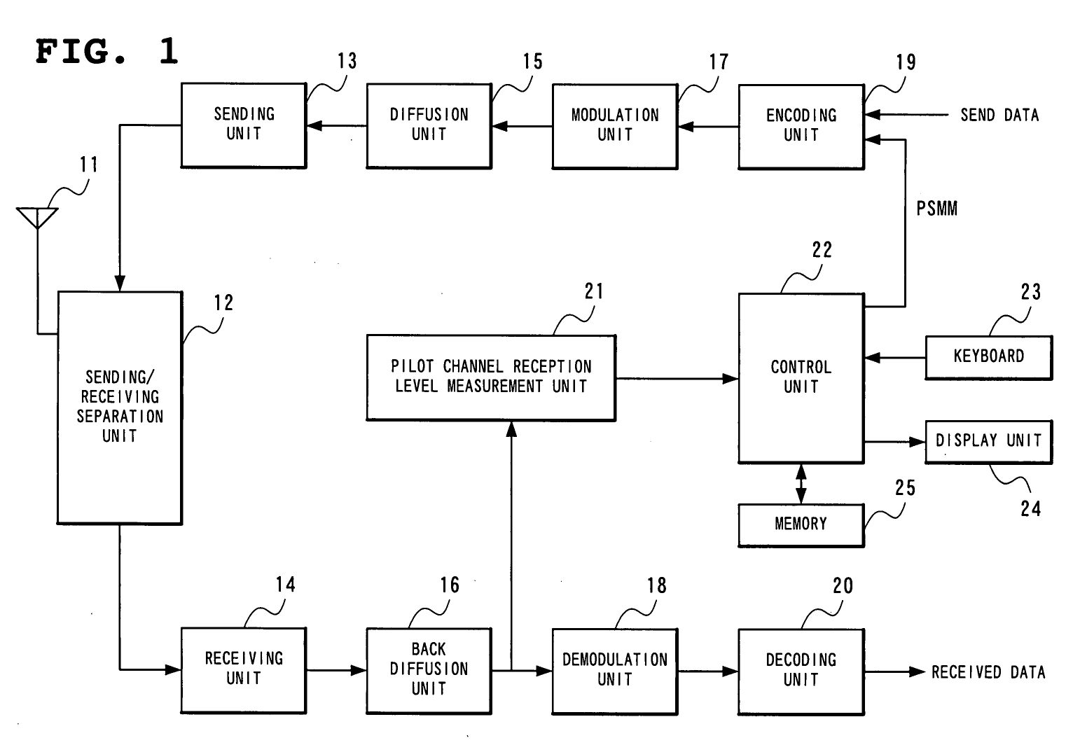

FIG. 1 is a block diagram illustrating the embodiment of a mobile communication terminal device, such as mobile phone, to which the present invention is applied. Although the basic configuration of the mobile communication terminal device is similar to that of a conventional mobile phone, FIG. 1 mainly shows only those blocks related to the description of the operation of the present invention.

In FIG. 1, a sending/receiving separation unit 12 outputs a radio frequency signal received from a base station via an antenna 11 to a receiving unit 14, and sends the radio frequency signal entered by a sending unit 13 to the base station via the antenna 11.

The receiving unit 14 performs processes such as down conversion and AGC on the signal received via the antenna 11.

A back diffusion unit 16 performs back diffusion processing on the received signal with a diffusion code assigned to each channel.

A demodulation unit 18 demodulates signals after back diffusion, such as QPSK. A decoding unit 20 performs processes of error-correction decoding and CRC on the demodulated signal, as well as decoding the received signal. Thus, received data is obtained.

The mobile communication terminal device always receives a pilot channel signal that is sent from the base station with a constant power, a pilot channel reception level measurement unit 21 measures a pilot channel signal reception level received from each base station, and outputs the measured pilot channel signal reception level data to a control unit 22.

Based on the pilot channel signal reception level data of each base station entered from the pilot channel reception level measurement unit 21, the control unit 22 controls the establishment of a Radio Link (RL), and the start and end of a soft handover; however, in the present embodiment, when the soft handover event occurs while the mobile communication terminal device is executing a call connection sequence, the control unit 22 outputs a control signal for notifying the start and end of the handover according to the after-mentioned criterion of the present invention.

Further, although not shown, in addition to the above-described control, the control unit 22 is organized as a control unit (central processing unit: CPU) that outputs various control signals to control the operation of the mobile communication terminal device to the corresponding blocks. A memory unit 25 contains various control programs for controlling the operation of the mobile communication terminal device, including the control of the present invention at the control unit 22, data for the control, or the like.

An encoding unit 19 performs convolution coding and CRC coding on the send data to form a send frame. In so doing, a control signal to notify the start or the end of the handover that is outputted from the control unit 22 to the base station, or the like, is also embedded.

A modulation unit 17 performs modulation such as QPSK on the send data. A diffusion unit 15 performs diffusion on the modulated send signal with the diffusion code assigned to each channel.

The sending unit 13 performs sending power control, up-conversion, or the like, on the diffused send signal, which, in turn, is sent to the antenna 11 via the sending/receiving separation unit 12.

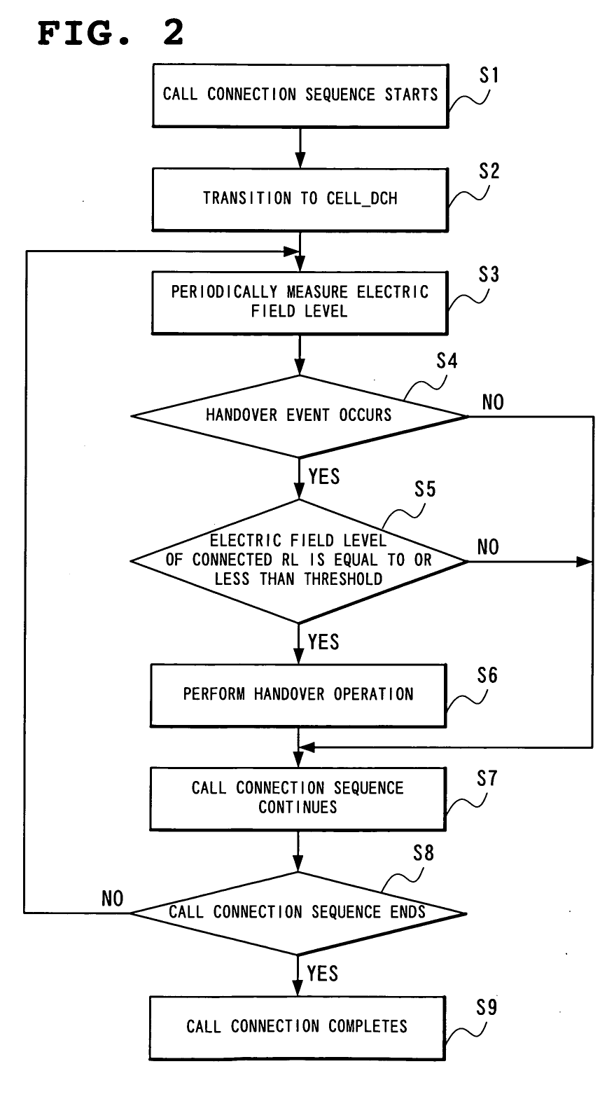

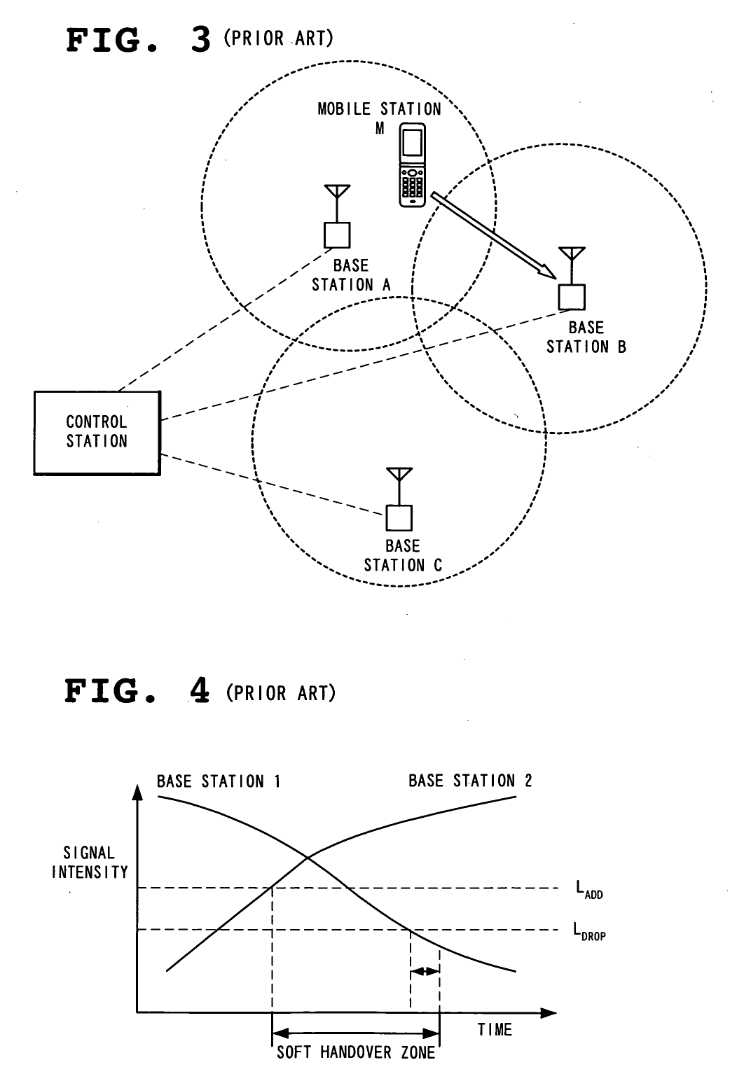

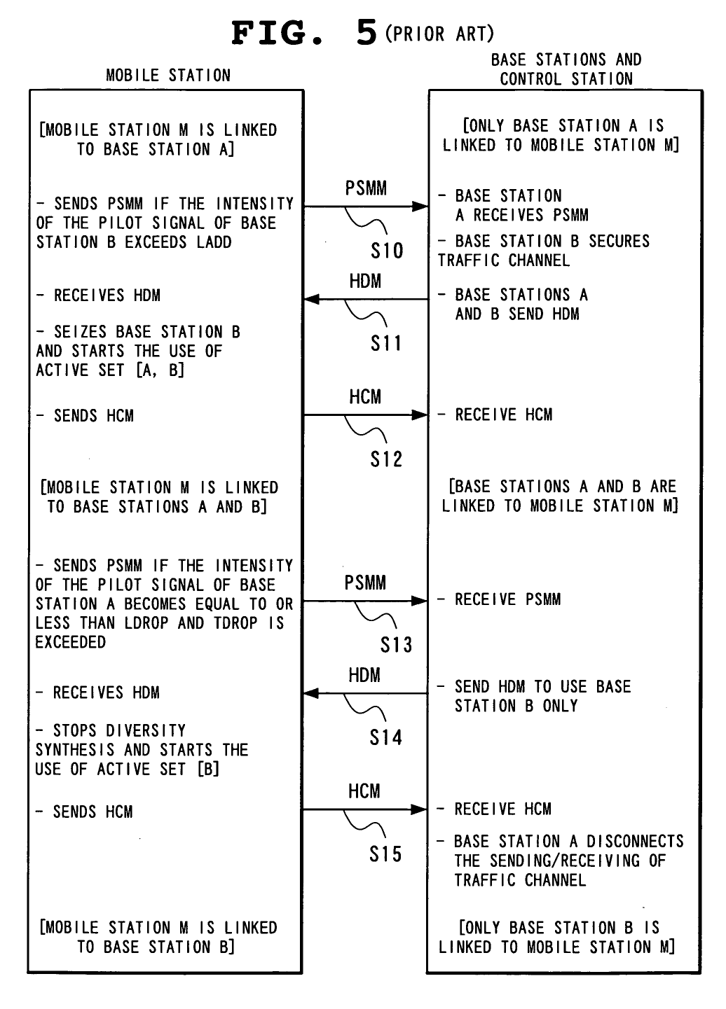

FIG. 2 is a flow chart illustrating the embodiment of the handover control operation during a call connection operation in the present invention. The handover control during the call connection operation in the present invention is performed at the control unit 22 according to the control program stored in the memory 25. The handover control operation according to the present invention will now be described assuming the mobile communication terminal device (mobile station M) is located in a mobile network using CDMA shown in FIG. 3.

The mobile communication terminal device M located in an area of the base station A is connected to the base station A by an RL (Radio Link). When a call originates by operating a key on a keyboard 23 on the mobile communication terminal device M, the control unit 22 starts a call connection sequence (Step S1), and opens a DCH. Upon transition to a CELL_DCH (Step S2) state, communication with 2RL (Radio Link) or 3RL (Radio Link) becomes possible.

If the position of the mobile communication terminal device M at the start of the call connection sequence is near an area of the base station B, upon transition to the CELL_DCH state, at the point of time when the electric field level of the pilot channel signal of the base station B becomes greater than a prescribed threshold “LADD” (second threshold), or at the point of time when the difference between the pilot channel signal reception levels from the base station A and from the base station B becomes equal to or less than, for example, 3 dB, as a result of the periodically performed measurement (Step S3) of the electric level of the pilot channel signal (pilot channel signal reception level) from the base station, a handover event occurs (Step S4).

When the handover event occurs, the control unit 22 compares the pilot channel signal reception level of the RL (Radio Link) with the currently connected base station A with a prescribed threshold (first threshold) (Step S5). The threshold (first threshold) is the minimum electric level required for a call connection to succeed, and is set to a greater value than the threshold “LADD” for connecting a channel. In regard to the threshold (first threshold), an appropriate threshold can be set in advance through reception tests performed by terminal developing manufacturers or carriers.

When the threshold is set by a carrier, it is reported to a terminal by a Measurement Control or the like and stored in the memory 25, on the other hand, when the threshold is set by a terminal developing manufacturer, it is written into and stored in the memory 25 inside the terminal, in advance.

If, as a result of the comparison in Step S5, the electric field level of the RL (Radio Link) of the currently connected base station A is equal to or less than the threshold (first threshold) (YES in Step S5), the call connection sequence is interrupted and a handover operation is performed (Step S6). That is, the mobile communication terminal device M performs the handover sequence in priority by sending a pilot channel signal measurement message (PSMM) to the base station A. Then, after completion of the handover operation, the call connection sequence is resumed (Step S7).

Conversely, if the electric level of the currently connected RL (Radio Link) is greater than the threshold (NO in Step S5), it is determined that the call connection will succeed even if the handover operation is not performed, and the call connection sequence is continued without performing the handover operation (Step S7).

Thereafter, similarly, when a handover event occurs at the periodical measurement of the electric level until the call connection sequence is completed, the following operation is repeated (Step S8): the electric level of the currently connected RL and the threshold are compared, and if the electric level of the connected RL (Radio Link) is equal to or less than the threshold, the handover operation is performed, whereafter the call connection sequence is resumed, conversely, if the electric level of the connected RL is greater than the threshold, the call connection sequence is continued.

After the call connection sequence ends (YES in Step 8), a call connection is completed (Step 9) and a call state is entered, every time when a soft handover event occurs during the call, the soft handover operation is performed as usual.

According to the handover control method during a call connection operation of the present invention, when a handover event occurs during a call connection operation, if the electric field level of the connected RL (Radio Link) is above the threshold, the handover operation is not performed, thereby ensuring that the call connection sequence is executed without spending extra time on the call connection, and if the electric field level of the connected RL is equal to or less than the threshold, the handover operation is immediately performed in order to bring the electric field level of the RL to a substantially good condition before executing the call connection operation, which allows the problem of failing calls to be resolved.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A soft handover control method of a mobile communication terminal device using CDMA, comprising the steps of:
detecting the occurrence of a handover event while said mobile communication terminal device is performing a call connection operation; and
when said handover event is detected, controlling the switching between giving priority to the continuation of the call connection sequence, and continuing said call connection sequence after performing a handover sequence, depending on the electric field level of the currently connected Radio Link (RL).

2. The soft handover control method as set forth in claim 1, wherein
if said electric field level of the currently connected Radio Link (RL) is
greater than a minimum value of the electric field level required for a call connection to succeed, said call connection sequence is continued in priority, and if said electric field level is
equal to or less than the minimum value of the electric field level required for a call connection to succeed, said handover sequence is performed in priority, then said call connection sequence is continued.

3. The soft handover control method as set forth in claim 1, comprising the steps of:
periodically receiving a pilot signal sent from a base station to measure the reception level thereof;
executing a call connection sequence via the base station for which said Radio Link (RL) is established according to a calling direction entered via a keyboard;
during said call connection sequence, when the occurrence of a handover event is detected, continuing said call connection sequence without performing the soft handover operation due to said handover event if the pilot signal level received from the base station for which said Radio Link (RL) is established is greater than said first threshold; and
performing the soft handover operation due to said handover event if the pilot signal level received from the base station for which said Radio Link (RL) is established is equal to or less than said first threshold, and continuing said call connection sequence after completion of the soft handover operation.

4. The soft handover control method as set forth in claim 3, wherein
a Radio Link (RL) is established with a base station for which the measured level of said pilot signal is greater than a second threshold, and
when a handover event occurs during execution of said call connection sequence, the pilot signal level received from the base station for which said Radio Link (RL) is established is compared with said threshold.

5. The soft handover control method as set forth in claim 3, wherein
said first threshold has a greater value than said second threshold, and is set to a minimum electric field level required for said call connection to succeed.

6. A mobile communication terminal device using CDMA, comprising:
unit which detects the occurrence of a handover event while said mobile communication terminal device is performing a call connection operation; and
unit which controls, when said handover event is detected, the switching between giving priority to the continuation of the call connection sequence and continuing said call connection sequence after performing the handover sequence, depending on the electric field level of the currently connected Radio Link (RL).

7. A mobile communication terminal device using CDMA, comprising:
a pilot signal level measurement unit which periodically receives a pilot signal sent from a base station to measure the reception level thereof;
unit which causes a handover event;
unit which executes a call connection sequence via a base station for which said Radio Link (RL) is established according to a calling direction entered via a keyboard;
unit which performs upon the occurrence of the handover event during execution of said call connection sequence, continuation of said call connection sequence without performing the soft handover operation due to said handover event if the pilot signal level received from the base station for which said Radio Link (RL) is established is greater than a preset threshold, and, performing the soft handover operation due to said handover event and continuation of said call connection sequence after completion of the soft handover operation if the pilot signal level received from the base station for which said Radio Link (RL) is established is equal to or less than said threshold.

8. The mobile communication terminal device using CDMA as set forth in claim 7, comprising:
unit which establishes a Radio Link (RL) with a base station for which the level of the received pilot signal measured by said pilot signal level measurement unit is greater than a second threshold, and
unit which compares the pilot signal level received from the base station for which said Radio Link (RL) is established with said threshold when the handover event occurs during execution of said call connection sequence.

9. The mobile communication terminal device using CDMA as set forth in claim 7, wherein
said handover event causing unit causes the handover event when a second base station that can receive a greater pilot signal than said first threshold is detected by said pilot signal level measurement unit, or when the difference between the pilot signal level received from the base station for which said Radio Link (RL) is established and the pilot signal reception level from the second base station is equal to or less than a prescribed value.

10. The mobile communication terminal device using CDMA as set forth in claim 7, wherein
said first threshold has a greater value than said second threshold, and is set to a minimum electric field level required for said call connection to succeed.

11. The mobile communication terminal device using CDMA as set forth in claim 7, wherein
said handover event causing unit causes the handover event when a second base station that can receive a greater pilot signal than said second threshold is detected by said pilot signal level measurement unit, or when the difference between the pilot signal level received from the base station for which said Radio Link (RL) is established and the pilot signal reception level from the second base station is equal to or less than a prescribed value, and
said first threshold has a greater value than said second threshold, and is set to a minimum electric field level required for said call connection to succeed.

12. A program causing a control unit included in a mobile communication terminal device using CDMA to perform a soft handover control, performing
the process of detecting the occurrence of a handover event during a call connection operation,
the process of comparing an electric field level of a currently connected Radio Link (RL) with a preset threshold when the occurrence of said handover event is detected,
the process of controlling the continuation of said call connection operation if the electric level of the currently connected Radio Link (RL) is greater than said threshold, and
the process of controlling the continuation of said call connection operation after performing the handover sequence in priority if the electric level of the currently connected Radio Link (RL) is equal to or less than said threshold.

13. The program as set forth in claim 12, wherein
said threshold is set to a minimum electric field level required for a call connection to succeed.
